(19) United States
(12) Patent Application Publication
(10) Pub. No.: US 2009/0153470 A1
(43) Pub. Date: Jun. 18, 2009

(54) ELECTRONIC DEVICE WITH MODULE INTEGRATING DISPLAY UNIT AND INPUT UNIT

(76) Inventors: Ming-Yu Chen, Tao-Yuan City (TW); Chao-Yi Chen, Tao-Yuan City (TW); Cheng-Chieh Chuang, Taoyuan County (TW); Chi-Nien Chen, Tao-Yuan City (TW)

Correspondence Address: NORTH AMERICA INTELLECTUAL PROPERTY CORPORATION, P.O. BOX 506, MERRIFIELD, VA, 22116, US

(21) Appl. No.: 12/210,219

(22) Filed: Sep. 15, 2008

(30) Foreign Application Priority Data
Dec. 18, 2007 (TW) 096148416

(51) Int. Cl. G09G 5/00

(52) U.S. Cl. 345/156; 345/4

(57) ABSTRACT

An electronic device includes a housing, a main display unit, an auxiliary display module and a processor. The main display unit and the auxiliary display module are both disposed on the housing. The auxiliary display module includes an auxiliary display unit and an input unit. The auxiliary display unit is used for displaying a user interface, and the input unit is used for receiving a user input. The processor is coupled to the input unit, and performs a corresponding function according to the user input.

### BACKGROUND

1. Technical Field

The application relates to an electronic device, and more particularly, to an electronic device having a main display unit, and an auxiliary display module, which is able to receive a user input from a user interface.

2. Description of the Prior Art

In general, a display unit and input unit are two independent parts in a handheld electronic device, such as a clamshell mobile phone, a sliding mobile phone or personal digital assistant (PDA). Taking a dual-screen mobile phone for example, the input unit (e.g. keys or QWERTY keypads) and an auxiliary display are two independent parts, so they occupy a large space on the surface of the mobile phone. For a smaller mobile phone, it is necessary to use smaller keys or a smaller display to compromise the smaller volume of the phone. This would lead to the smaller phone becoming difficult to operate. In addition, the two independent displays of the dual-screen mobile phone are not able to show information when the mobile phone is in a stand-by mode. Taking a PDA as another example, when the PDA enters a stand-by mode, the display (the display unit) is turned off to save power, and the user cannot read any information from the PDA via the display. Under this situation, if the user wants to know certain information (e.g., the current time) from the PDA, the user needs to activate the PDA to make the PDA re-enter an operation mode from the stand-by mode so as to turn on the display to read information. This is very inconvenient for the user.

### SUMMARY

It is therefore one of the objectives of the application to provide an electronic device that integrates a display unit and an input unit into an auxiliary display module, in order to solve the above-mentioned problem.

According to an exemplary embodiment of the application, an electronic device is disclosed. The electronic device comprises: a housing; a main display unit, which is disposed on the housing; an auxiliary display module, which is disposed on the housing, and comprises an auxiliary display unit for displaying a user interface and an input unit for receiving a user input; and a processor, which is coupled to the input unit, and is for performing a corresponding function according to the user input.

According to an exemplary embodiment of the application, an electronic device is also disclosed. The electronic device comprises: a first housing; a second housing, which is connected with the first housing and capable of sliding with each other; a main display unit, which is disposed on the first housing; an auxiliary display module, which is disposed on the second housing, and comprises: an auxiliary display unit for displaying a user interface and an input unit for receiving a user input; and a processor, which is coupled to the input unit, and is for performing a corresponding function according to the user input.

These and other objectives of the application will no doubt become obvious to those of ordinary skill in the art after reading the following detailed description of the embodiment that is illustrated in the various figures and drawings.

### BRIEF DESCRIPTION OF THE DRAWINGS

FIG. 1 depicts a block diagram illustrating an electronic device according to a first embodiment of the present invention.

FIG. 2 depicts a diagram illustrating the electronic device shown in FIG. 1 executing a built-in mobile phone application program in the operation mode.

FIG. 3 depicts a diagram illustrating the electronic device shown in FIG. 1 executing a multimedia playback application program in the operation mode.

FIG. 4 depicts a diagram illustrating the electronic device shown in FIG. 1 displaying caller-ID information in the stand-by mode.

FIG. 5 depicts a diagram illustrating the electronic device shown in FIG. 1 displaying missed calls, unread messages and unread mail information in the stand-by mode.

FIG. 6 depicts a diagram illustrating the electronic device shown in FIG. 1 displaying time information in the stand-by mode.

FIG. 7 depicts a diagram illustrating an electronic device according to a second embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “electrically connect” is intended to mean either an indirect or direct electrical connection. Accordingly, if one device is coupled to another device, that connection may be through a direct electrical connection, or through an indirect electrical connection via other devices and connections.

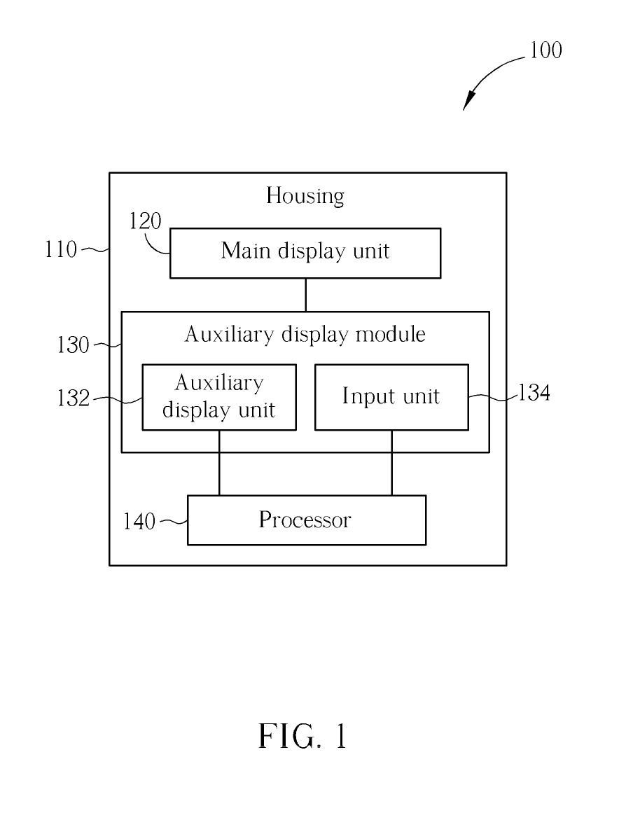

Please refer to FIG. 1. FIG. 1 is a block diagram illustrating an electronic device 100 according to a first embodiment of the present invention. As shown in FIG. 1, the electronic device 100 comprises a housing 110, a main display unit 120, an auxiliary display module 130 and a processor 140. The main display unit 120 and the auxiliary display module 130 are both disposed on the housing 110. The auxiliary display module 130 comprises an auxiliary display unit 132 and an input unit 134. The processor 140 is coupled to the auxiliary display unit 132, the input unit 134 and the main display unit 120. In the auxiliary display module 130 of this embodiment, the auxiliary display unit 132 could be implemented by a bi-stable display, such as an e-paper or an interferometric modulation (IMOD), and the input unit 134 is implemented by a touch sensor, such as a touch panel and is disposed on the auxiliary display unit 132; however, this is not a limitation of the application. For example, the auxiliary display unit 132 of the auxiliary display module 130 may be a flexible display, and the input unit 134 of the auxiliary display module 130 may be a non-touch sensor. Further description of the electronic device 100 is detailed as follows. In this embodiment, the electronic device 100 is a bar-type electronic device; however, this is merely for illustrative purposes and is not a limitation of the application. In other embodiments of the present invention, the electronic device 100 may be a handheld communication device, a handheld computing device or a PDA.

When the electronic device 100 is in a first mode named operation mode, the processor 140 would enable and control the display function of both the main display unit 120 and the auxiliary display unit 132 of the auxiliary display module 130. The auxiliary display unit 132 is utilized for displaying a user interface, and a user can communicate with or operate the electronic device 100 via the user interface. When the input unit 134 of the auxiliary display module 130 receives a user input from the user interface, the processor 140 performs a corresponding function according to the user input. Additionally, the processor 140 would determine the user interface displayed on the auxiliary display unit 132 based on a specific application program executed by the electronic device 100. In other words, the user interface could be a variable function key corresponding to the specific application program executed by the processor 140, the user interface might be: a navigator, a QWERTY keyboard, a phone keypad, a multimedia playback key set, a scroll bar, a scroll wheel or any kind of function key.

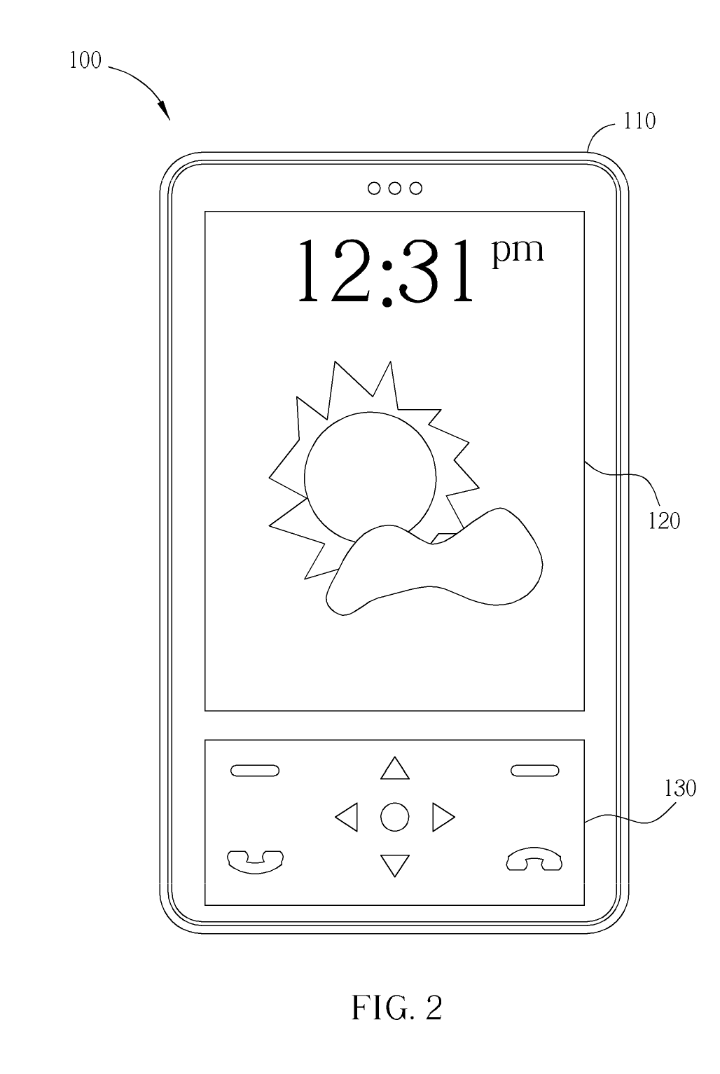

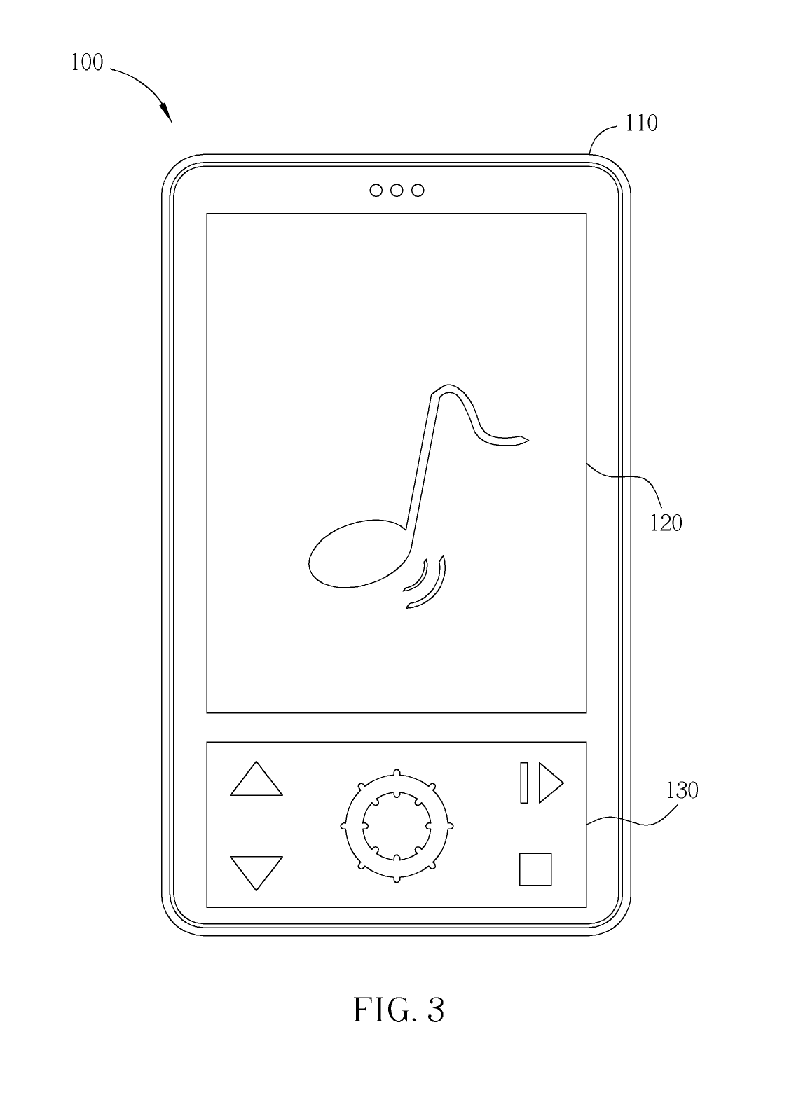

Please refer to FIG. 2 and FIG. 3. FIG. 2 is a diagram illustrating the electronic device 100 shown in FIG. 1 executing one of a built-in mobile phone application programs in the operation mode. FIG. 3 is a diagram illustrating the electronic device 100 shown in FIG. 1 executing a multimedia playback application program in the operation mode. As shown in FIG. 2, when the electronic device 100 executes the application program, meanwhile the main display unit 120 would display the specific information in response to the application program, the processor 140 controls the auxiliary display unit 132 of the auxiliary display module 130 to display a user interface corresponding to the application program executed (e.g., a phone keypad). In this way, a user can operate the electronic device 100 via the phone keypad to use the various functions of the phone, such as answering, hanging up or making a phone call. Thus, the auxiliary display unit 132 is capable of displaying different kind of user interface based on the current application program executed in the electronic device 100 and showing the corresponding information in the main display unit 120. As shown in FIG. 3, when the electronic device 100 executes the multimedia playback application program, the processor 140 controls the auxiliary display unit 132 of the auxiliary display module 130 to display a user interface corresponding to the multimedia playback application program (e.g., a multimedia playback key set). In this way, a user can operate the electronic device 100 via the multimedia playback key set to use the various functions of the multimedia player, such as playing music or videos.

When the electronic device 100 switch to a second mode named stand-by mode, the processor 140 will disable the display function of the main display unit 120 to save the power of the electronic device 100. The processor 140 keeps enabling the display function of the auxiliary display unit 132 of the auxiliary display module 130 and control the auxiliary display unit 132 to display a message corresponding to a predetermined information type. The predetermined information type may include: date, time, missed calls, unread messages, unread mails and so on.

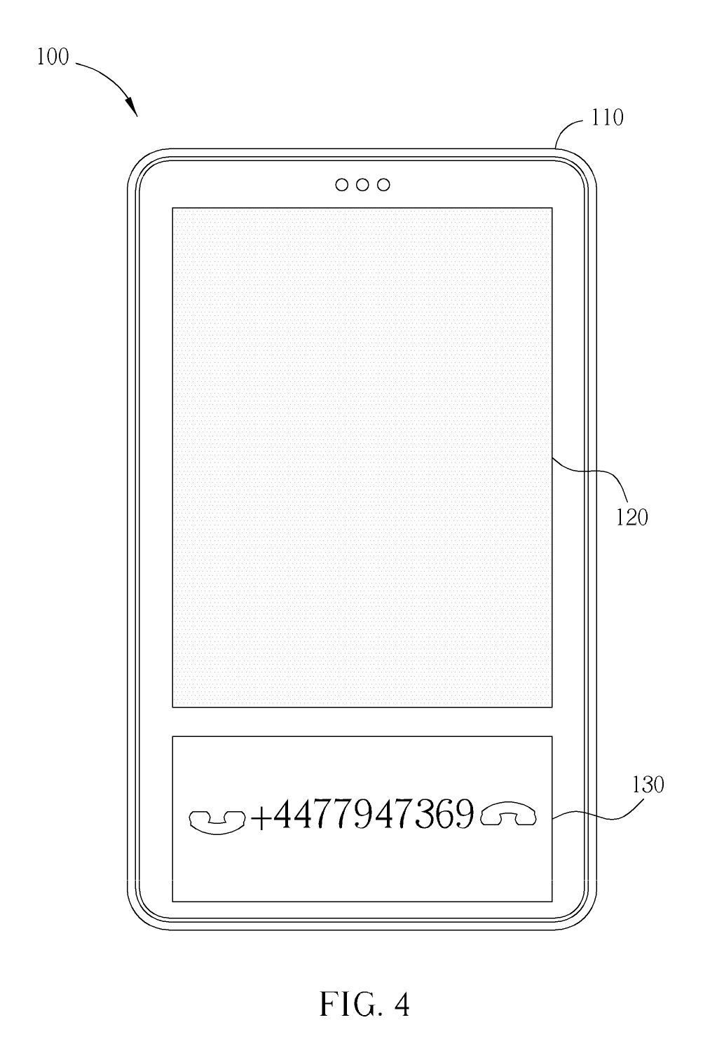

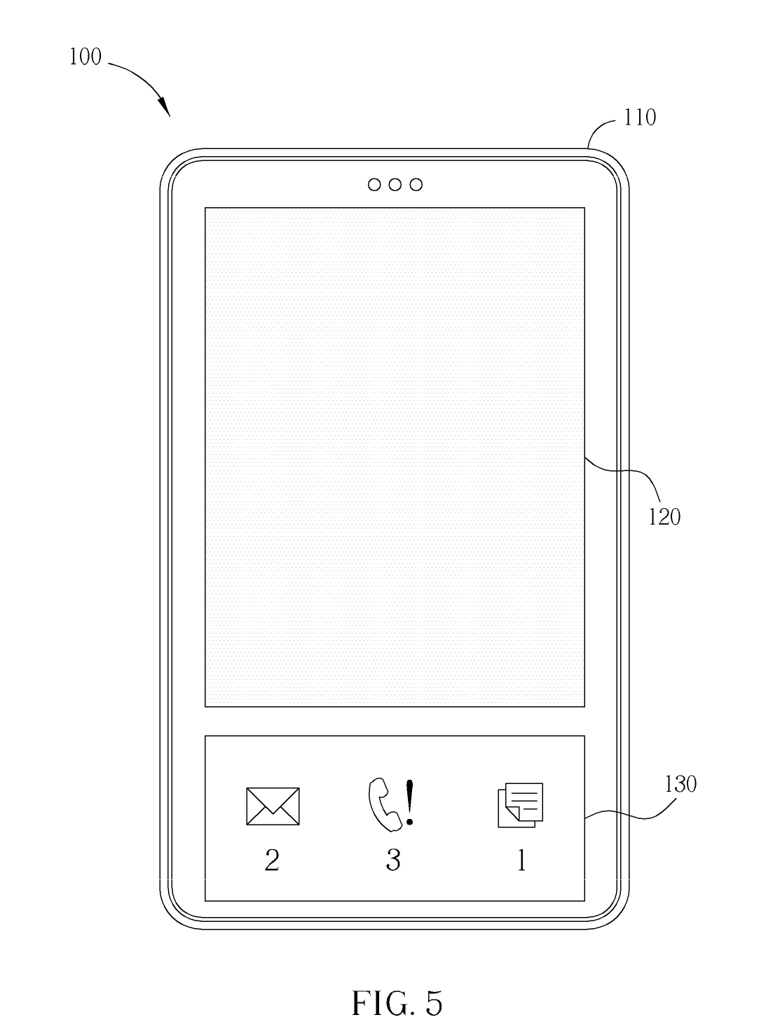

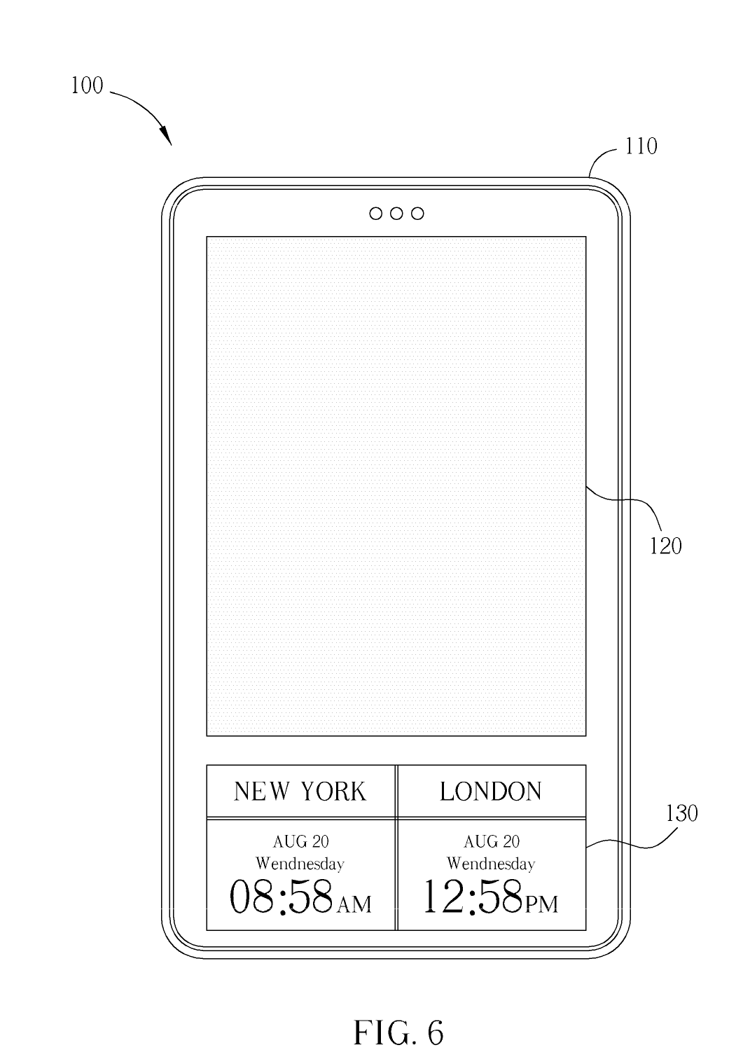

Please refer to FIG. 4, FIG. 5 and FIG. 6. FIG. 4 is a diagram illustrating the electronic device 100 shown in FIG. 1 displaying caller-ID information (i.e., a call-in number but the user did not pick up the call at that time) in the stand-by mode. FIG. 5 is a diagram illustrating the electronic device 100 shown in FIG. 1 displaying missed calls, unread messages and unread mails information in the stand-by mode. In other words, the main display unit 120 is disabled and the auxiliary display module 130 still can provide some specific information for the user. As described above, the processor 140 keeps enabling the display function of the auxiliary display unit 132 of the auxiliary display module 130. Further, the auxiliary display unit 132 can be implemented by the e-paper with its lower-power-consumption advantage. FIG. 6 is a diagram illustrating the electronic device 100 shown in FIG. 1 displaying basic time information in different place in the stand-by mode. In the above embodiments, the display function of the main display unit 120 is disabled and only enables the auxiliary display unit 132 to pass or transfer the specific messages for the users. In addition, the auxiliary display unit 132 is a bi-stable display with a low power consumption display. Thus, the user can receive the newest information at time from the electronic device without needing to re-activate it.

In this embodiment, the auxiliary display module 130 further comprises a key switch, which is disposed under the auxiliary display unit 132. When the user uses the auxiliary display module 130 to input data or make a command, the key switch provides a haptic feedback to the user when the input unit 134 receives a user input. Therefore, the user is able to determine whether the operation of inputting data into the electronic device 100 is fully completed according to the haptic feedback. The key switch may be a dome switch, a membrane or a mechanical switch; however, this is not a limitation of the application. For example, in other embodiments of the present invention, the auxiliary display module 130 may further comprise a vibration generator. Similarly, when the user inputs data or makes a command via the auxiliary display module 130, the vibration generator provides a vibration feedback to the user when the input unit 134 receives a user input. Therefore, the user is also able to determine whether the operation of inputting data into the electronic device 100 is fully completed according to the vibration feedback. As mentioned above, the input unit 134 is a touch sensor (e.g., a touch panel) or a pressure sensor. A user can use his/her finger to press, move, drag, or pat on the surface of the input unit 134 to control the electronic device 100 to perform different functions.

Compared with the previous products or published patent documents, it can be seen that, since the electronic device of the application integrates the display unit and the input unit into an auxiliary display module, the interface displayed on the auxiliary display module is able to be changed based on the different specific application program executed by the processor. In addition to allowing a user to operate the electronic device, the auxiliary display module is also able to allow the user to read messages of all kinds of predetermined information types when the electronic device is in stand-by mode.

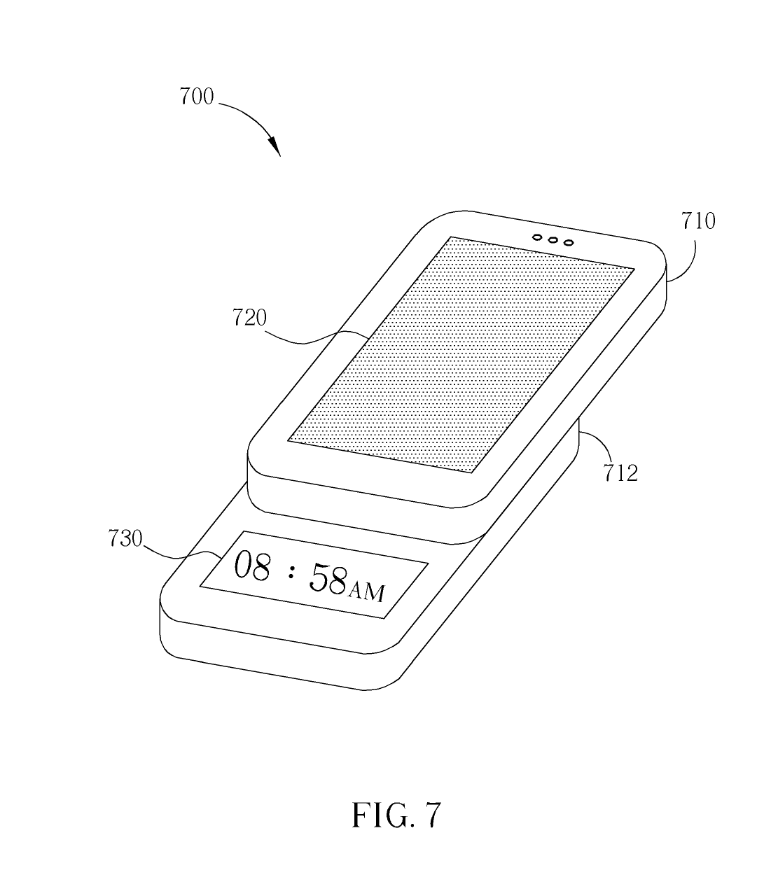

Please note that, in the above embodiments, the main display unit 120 and the auxiliary display module 130 are both disposed on the housing 110; however, this is not a limitation of the application. Please refer to FIG. 7. FIG. 7 is a diagram illustrating an electronic device 700 according to a second embodiment of the present invention. As shown in FIG. 7, the electronic device 700 comprises a first housing 710, a second housing 712, a main display unit 720, an auxiliary display module 730 and a processor 740 (not shown in FIG. 7). In which, the first housing 710 and the second housing 720 are connected and capable of sliding with each other. The main display unit 720 is disposed on the first housing 710, and the auxiliary display module 730 is disposed on the second housing 712. This alternative design also falls within the scope of the application.

Those skilled in the art will readily observe that numerous modifications and alterations of the device and method may be made while retaining the teachings of the application.

What is claimed is:

1. An electronic device, comprising:
a housing;
a main display unit disposed on the housing;
an auxiliary display module disposed on the housing, comprising:
an auxiliary display unit for displaying a user interface; and
an input unit for receiving a user input; and
a processor coupled to the input unit for performing a corresponding function according to the user input.

2. The electronic device of claim 1, wherein when the device is in a first operation mode, the processor is further coupled to the main display unit for determining the user interface displayed on the auxiliary display unit in response to the first operation mode.

3. The electronic device of claim 2, wherein the processor is further coupled to the auxiliary display unit and enables the auxiliary display unit to display the user interface; and when the device switches to a second operation mode, the processor keeps enabling the auxiliary display unit.

4. The electronic device of claim 3, wherein when the device is in the second operation mode, the processor further disables the main display unit and controls the auxiliary display unit to display a message corresponding to a predetermined information type.

5. The electronic device of claim 1, wherein the user interface is a navigator, a QWERTY keyboard, a phone keypad, a multimedia playback key set, a scroll bar, a scroll wheel or a function key corresponding to a specific application program.

6. The electronic device of claim 1, wherein the auxiliary display unit is a flexible display or a bi-stable display.

7. The electronic device of claim 6, wherein the bi-stable display is an e-paper or an interferometric modulation (IMOD).

8. The electronic device of claim 1, wherein the input unit is a touch sensor, and the auxiliary display module further comprises a key switch for providing a haptic feedback when the touch sensor receives the user input.

9. The electronic device of claim 8, wherein the key switch is a dome switch, a membrane or a mechanical switch.

10. The electronic device of claim 8, wherein the touch sensor is a touch pad disposed on the auxiliary display unit.

11. The electronic device of claim 1, wherein the input unit is a touch sensor, and the auxiliary display module further comprises a vibration generator for providing a vibration feedback when the touch sensor receives the user input.

12. The electronic device of claim 11, wherein the touch sensor is a touch pad disposed on the auxiliary display unit.

13. The electronic device of claim 1, being a handheld communication device or a handheld computing device.

14. An electronic device, comprising:
a first housing;
a second housing connected with the first housing and capable of sliding with each other;
a main display unit disposed on the first housing;
an auxiliary display module disposed on the second housing, comprising:
an auxiliary display unit for displaying a user interface; and
an input unit for receiving a user input; and
a processor coupled to the input unit for performing a corresponding function according to the user input.
